(19) United States
(12) Patent Application Publication
(10) Pub. No.: US 2026/0002558 A1
(43) Pub. Date: Jan. 1, 2026

(54) VALVE ARRANGEMENT, ACTUATOR AND CLAMP FOR A VALVE ARRANGEMENT, METHOD FOR ASSEMBLING A VALVE AND ACTUATOR AND CLAMP

(71) Applicant: DANFOSS A/S, Nordborg (DK)

(72) Inventors: Mikkel FRANK, Nordborg (DK); Kristian THERKILDSEN, Nordborg (DK)

(21) Appl. No.: 19/129,976

(22) PCT Filed: Nov. 1, 2023
(86) PCT No.: PCT/EP2023/080465

§ 371 Date: May 15, 2025

(30) Foreign Application Priority Data
Nov. 21, 2022 (DK) PA202201064

(51) Int. Cl. F16B 7/04; F16B 2/06; F16K 31/04

(52) U.S. Cl. CPC F16B 7/0426; F16B 2/065; F16K 31/04

(57) ABSTRACT

The present invention pertains to a valve arrangement comprising a valve with a valve connection geometry, an actuator with an actuator connection geometry and a clamp fixing the valve to the actuator, wherein each connection geometry comprises an inner contact surface for contacting the valve to the actuator, and wherein each connection geometry comprises a radially outward pointing protrusion, each with an outer contact surface for contacting the clamp, wherein each outer contact surface is shaped at least partially as a frustum. The invention also pertains to an actuator and clamp for a valve arrangement, a method for assembling a valve arrangement, and an actuator for actuating a valve with a clamp for fixing the actuator to the valve.

The present invention pertains to a valve arrangement comprising a valve with a valve connection geometry, an actuator with an actuator connection geometry and a clamp fixing the valve to the actuator, wherein each connection geometry comprises an inner contact surface for contacting the valve to the actuator, and wherein each connection geometry comprises a radially outward pointing protrusion, each with an outer contact surface for contacting the clamp, wherein each outer contact surface is shaped at least partially as a frustum. The invention also pertains to an actuator and clamp for a valve arrangement, a method for assembling a valve arrangement, and an actuator for actuating a valve with a clamp for fixing the actuator to the valve.

Known actuator operated valve arrangements may be used in confined spaces. The personnel access to these valve arrangements may be hence limited such that assembly and disassembly of the arrangements is problematic. In particular, the connection of the actuator to the valve and the disconnection of the actuator from the valve may be complicated by other structures situated close to the valve. Such structures may limit the space available for positioning the actuator relative to the valve.

In a situation, in which an actuator has to be connected to or disconnected from a valve, it may therefore be difficult to access the area, in which the two components are connected to each other. In particular, it may be difficult to apply tools necessary for connecting and disconnecting the two components and it may be difficult to align the actuator and the valve such that the two components may be connected correctly.

The aim of the present invention is to overcome this problem by providing an improved connection between the valve and the actuator and an improved method for assembling an actuator valve assembly. The aim is achieved by a valve arrangement according to claim 1, an actuator and clamp according to claim 8, a method according to claim 9 for assembling the valve arrangement and an actuator with a clamp according to claim 10. Preferable embodiments of the invention are subject to the dependent claims.

According to the invention, the valve arrangement comprises a valve with a valve connection geometry, an actuator with an actuator connection geometry, and a clamp fixing the valve to the actuator. In one aspect of the invention, the valve may be provided with two fluid ports. The clamp provides a detachable connection between the valve and the actuator. Each connection geometry of the actuator and the valve comprises an inner contact surface for contacting the valve to the actuator. Each connection geometry comprises also a radially outward pointing protrusion, each with an outer contact surface for contacting the clamp, wherein each outer contact surface is shaped at least partially as a frustum. The outer contact surfaces may be angled such that the actuator and the valve are pressed against each other in an axial direction by the clamp. This means that a radially acting clamping force exerted by the clamp is used for pressing the valve against the actuator in an axial direction thereof. The axial direction of the arrangement and its components may correspond to the axis of rotation of the actuator. The radial direction of the arrangement and its components may correspond to the directions perpendicular to the axial direction.

In a preferred embodiment of the invention, the clamp comprises a valve contact surface and an actuator contact surface, wherein the actuator contact surface is arranged asymmetrically to the valve contact surface with respect to a horizontal plane and/or all fluid passages of the valve are provided below the valve connection geometry. The horizontal plane may correspond to a plane perpendicular to the direction in which the valve and the actuator are arranged with respect to each other. The horizontal plane may extend in the radial directions of the arrangement. As all fluid passages of the valve may be provided below the valve connection geometry, the present invention pertains to valves in which no fluid flow occurs between their bottom portion and their upper portion situated closer to the attached actuator.

The contact surfaces are surfaces at which the clamp contacts the valve and the actuator. The asymmetrical contact surfaces of the clamp facilitate the connection of valves and actuators, which have different diameters at their connection geometries. In particular, the clamp facilitates the connection of valves and actuators, which are at least partially inserted into each other.

In a particularly preferred embodiment of the invention, the actuator contact surface is positioned further outside or inside in a radial direction of the arrangement than the valve contact surface. The different radial positions of the contact surfaces further facilitate the connection of valves and actuators, which have different diameters at their connection geometries.

In another particularly preferred embodiment of the invention, the valve contact surface is spaced apart from the actuator contact surface in a radial direction of the arrangement. Spacing apart the contact surfaces from each other facilitates the connection of valves and actuators, the diameters of which differ significantly. At the same time, the weight and dimensions of the clamp can be kept to a minimum.

In another particularly preferred embodiment of the invention, the valve contact surface is angled at a different slope than the actuator contact surface. The slopes of the contact surfaces of the clamp may be adapted to the thicknesses of the corresponding contact surfaces of the actuator and the valve. The thickness of the contact surfaces may correspond to their axial extension. For example, a thicker outer contact surface of the valve or actuator may be contacted by a steeper valve or actuator contact surface of the clamp. A steeper angle may correspond to an angle, which is closer to a 90° angle with respect to the axial direction of the clamp.

In another preferred embodiment of the invention, the clamp comprises an actuator opening for inserting the actuator and a valve opening for inserting the valve, wherein the actuator opening has a greater or smaller diameter than the valve opening and/or the clamp is permanently connected to the actuator and/or the clamp comprises two symmetrical halves, which are preferably permanently connected to each other by unscrewable screws. The two halves of the clamp may define the actuator opening and the valve opening, such that the two openings are situated radially within the halves. The unscrewable screws may be any type of screws, which are screwable with respect to a tapped hole within the clamp only to a degree, in which the screws do not leave the tapped hole entirely. This means that the screws cannot be unscrewed once they are screwed to the clamp. The screws may comprise some mechanism or some blocking portion, which prevent the screws from leaving the tapped hole entirely.

In another preferred embodiment of the invention, a seal is provided between the valve and the actuator, wherein the seal is arranged radially inside the inner contact surfaces and/or the valve is inserted at least partially into the actuator (3) and/or the valve connection geometry and/or the actuator connection geometry and/or a roller bearing are provided at the same axial position of the arrangement. The inner contact surfaces may be at least partially used for positioning the seal, thereby simplifying the design of the arrangement.

The valve may comprise some components required for the coupling of the valve to the actuator. For example, internal parts of a magnetic coupling may be provided together with the valve, which are magnetically coupled to external parts of the magnetic coupling provided with the actuator. The term valve may hence be understood in a broad sense and may comprise some components required for coupling the valve to the actuator.

The seal is provided for preventing moisture from entering the space between the valve and the actuator. The invention may be used as a part of a refrigeration system and correspondingly low temperatures may be encountered in its vicinity. The seal prevents moisture intrusion from the outside and into internal portions of the device. The seal therefore makes it possible to avoid ice formation within the device and reduces the risk of associated malfunctions.

There may be a narrow gap between the valve and the actuator at the uppermost portion of the valve, comprising coupling components such as parts of the magnetic coupling for coupling the valve to the actuator. The seal is not provided for sealing the contents of the valve against the outside as the valve is hermetically sealed in the relevant portion.

The present invention is also directed at an actuator and a clamp for a valve arrangement according to any of claims 1 to 7. The clamp is permanently connected to the actuator. The permanent connection may be provided by means of the unscrewable screws. The screws may connect two halves of the clamp such that the two halves cannot be disconnected without e.g. destroying the screws. The two halves may be connected sufficiently close to each other, such that the clamp permanently holds the actuator connection geometry of the actuator.

The present invention is also directed at a method for assembling a valve arrangement according to any of claims 1 to 9. The method comprises a first step, in which the actuator and the clamp are mounted onto the valve, while the actuator and the clamp are connected to each other, and a second step, in which the clamp is fastened to both, the actuator and the valve.

In the first step, the clamp and the actuator may be preferably permanently connected to each other, prior to the mounting of the actuator and the clamp onto the valve. Although the clamp may be permanently fixed to the actuator, the clamp may be movable to some degree with respect to the actuator. Only once the actuator is correctly positioned with respect to the valve may the screws of the clamp be tightened such that a rigid connection is provided between the clamp, the actuator and the valve.

In a preferred embodiment of the method, in the first step, the valve is inserted into the clamp through the valve opening of the clamp, and/or in the second step, the clamp is fastened by turning the screws.

The present invention is also directed at an actuator for actuating a valve, and a clamp for fixing the actuator to the valve. The actuator comprises an actuator connection geometry with an inner contact surface for contacting the actuator to the valve, wherein the actuator connection geometry comprises a radially outward pointing protrusion with an outer contact surface for contacting the clamp, wherein the outer contact surface is shaped at least partially as a frustum, and wherein the clamp is permanently connected to the actuator. The permanent connection between the clamp and the actuator may be provided in the previously described manner.

The present invention is also directed at clamp for a valve arrangement according to any of claims 1 to 8. The clamp comprises a valve contact surface and an actuator contact surface of different shapes and dimensions.

In a preferred embodiment of the invention, the clamp comprises two preferably symmetrical halves, which are preferably permanently connected to each other by unscrewable screws.

All features of the presently described embodiments of the invention may be combined with each other in any logically possible manner. Further details and advantages of the invention are described with reference to the figures. The figures show:

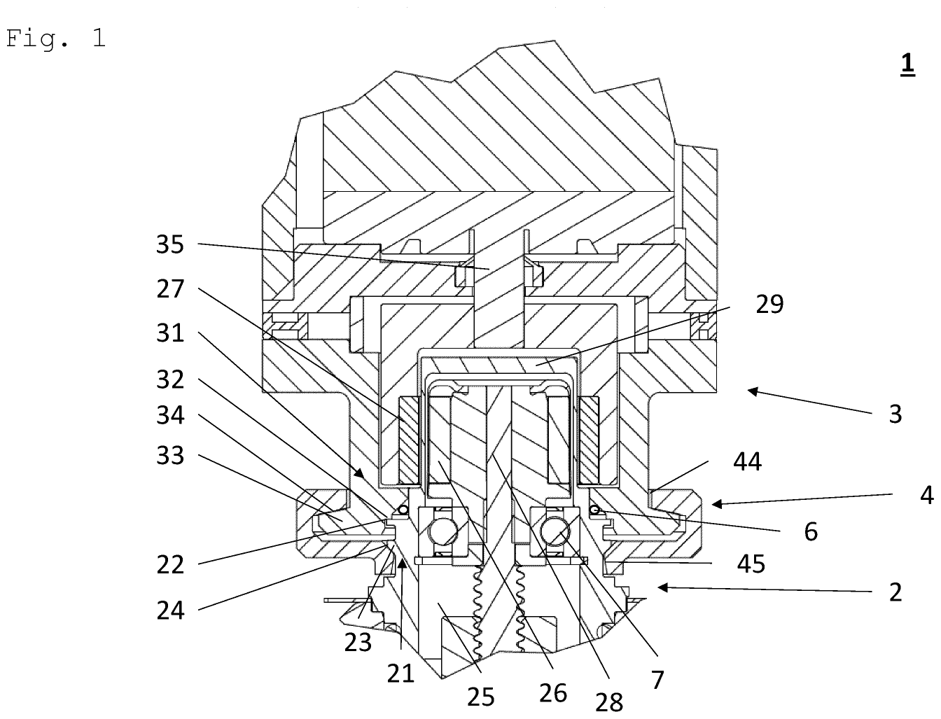

FIG. 1: a sectional view of an embodiment of the valve arrangement;

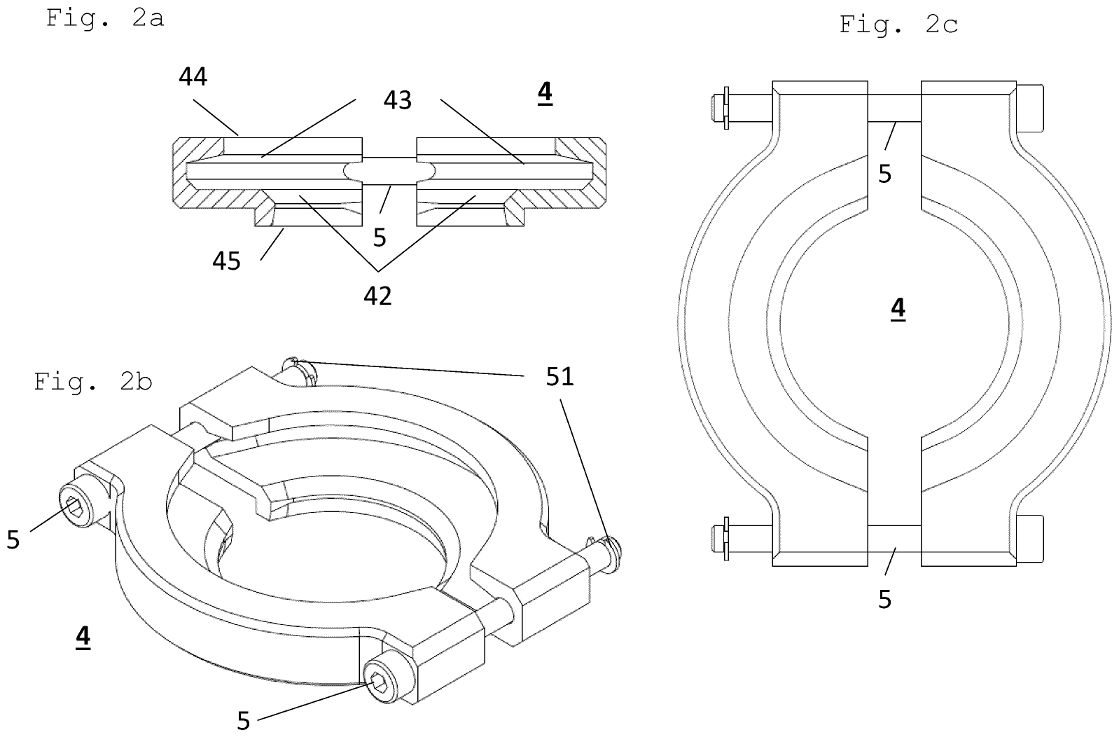

FIGS. 2a-2c: different views of an embodiment of the clamp, and

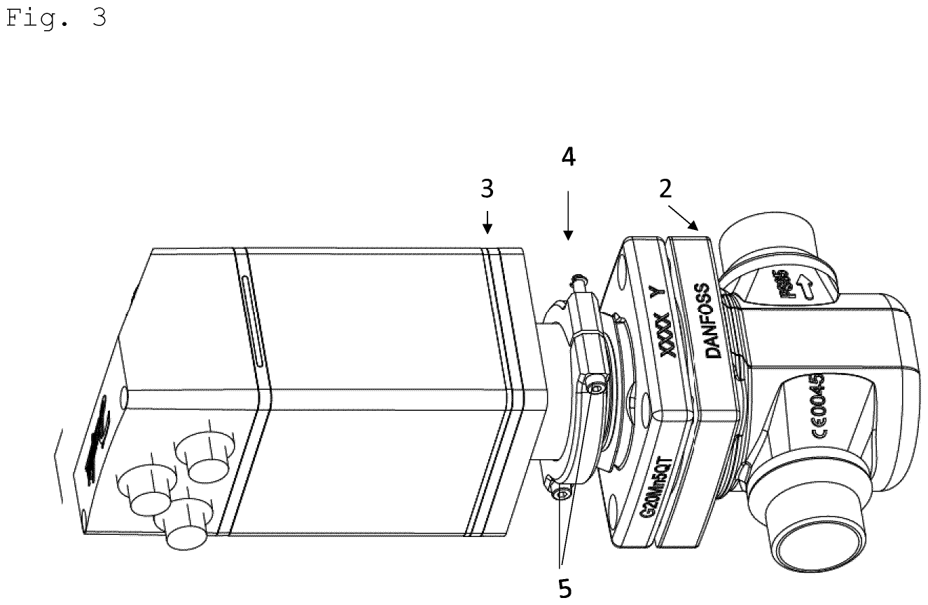

FIG. 3: a perspective view of an embodiment of the valve arrangement.

FIG. 1 shows a sectional view of an embodiment of the valve arrangement 1. Only the relevant connection portion of the valve arrangement 1 is shown. The valve arrangement 1 comprises a valve 2 with a valve connection geometry 21, an actuator 3 with an actuator connection geometry 31. The valve 2 and the actuator 3 are only shown partially, such that the connection geometries 21, 31 are shown in more detail. The actuator connection geometry 31 may be provided at the bottom most portion of the actuator 3.

A clamp 4 is provided for fixing the valve 2 to the actuator 3. The clamp 4 provides a detachable connection between the valve 2 and the actuator 3. In the connected condition of the arrangement 1 shown in FIG. 1, the clamp 4 is fixedly connected to the valve 2 and the actuator 3, providing a rigid connection between the valve 2 and the actuator 3.

Each connection geometry 21, 31 of the actuator 3 and the valve 2 comprises an inner contact surface 22, 32 for contacting the valve 2 to the actuator 3. The inner contact surfaces 22, 32 may be oriented in parallel to each other and/or extend in a radial direction of the arrangement 1. The inner contact surface 22 of the valve may be bound by a radially exterior circular face, wherein said radially exterior circular face may centre the valve 2 with respect to the actuator 3.

Each connection geometry 21, 31 also comprises a radially outward pointing protrusion 23, 33, each with an outer contact surface 24, 34 for contacting the clamp 4. The two outer contact surfaces 24, 34 are oriented away from each other. The outer contact surface 34 of the actuator may face away from the valve 2, while the outer contact surface of the valve may face away from the actuator 3. Each outer contact surface 24, 34 is shaped at least partially as a frustum. The outer contact surfaces 24, 34 may be frustums, which extend over 360° in a circumferential direction of the arrangement 1.

The two inner contact surfaces 22, 32 may be positioned radially inwards of the radially outward pointing protrusion 33 of the actuator 3. The outer contact surfaces 24, 34 may be angled such that the actuator 3 and the valve 2 are pressed against each other by the clamp 4. In particular, the clamp 4 may be pressed against the actuator 3 and the valve 2 in a radial direction of the arrangement by means of screws connecting two halves of the clamp 4.

The clamp 4 comprises an actuator opening 44 for inserting the actuator 3 and a valve opening 45 for inserting the valve 2. The openings 44, 45 are provided at axially opposite ends of the clamp 4. The actuator opening 44 has a greater diameter than the valve opening 45, however, the opposite diameter relation may be used in an alternative embodiment of the invention. The valve opening 45 and/or the actuator opening 44 may be tapered such that the openings are enlarged towards the lower and/or the upper end surface of the clamp 4. The tapering facilitates the mounting of the clamp to the valve 2 and/or the actuator 3.

The clamp 4 may be permanently connected to the actuator 3. This can be achieved by providing an actuator opening 44 at the clamp 4, which is smaller than the outermost diameter of the connection geometry 31 of the actuator 3. Even if the clamp 4 is not rigidly fixed to the valve 2, it may still remain partially slidably connected to the actuator 3.

A seal 6 is provided between the valve 2 and the actuator 3, wherein the seal 6 is arranged radially inside the inner contact surfaces 22, 32. The diameter of the seal 6 may be smaller than the innermost diameter of the clamp 4. The diameter of the seal 6 may correspond to the innermost diameter of the actuator connection geometry 31. The seal 6 may be provided in a toroidal volume provided between the valve 2 and the actuator 3 and extending in a circumferential direction of the arrangement 1, wherein the toroidal volume may have a triangular cross section. The seal 6 may reduce the risk of ice formation within the actuator 3 and/or at moving parts of the actuator 3, such as a magnetic coupling. Without sufficient sealing, moisture could accumulate at moving parts of the actuator 3. In low temperature conditions, said moisture could freeze and lead to rotational blocking of the magnets on the actuator side of the magnetic coupling and/or other components of the actuator 3.

The valve 2 is inserted at least partially into the actuator 3. The valve connection geometry 21 and/or the actuator connection geometry 31 and/or a roller bearing 7 may be provided at the same axial position of the arrangement 1, in particular at the same axial position as the clamp 4. This positioning ensures that forces applied by the clamp 4 into the valve arrangement 1 are well defined and resulting strains of the valve arrangement 1 remain within tolerable limits.

The inner contact surfaces 22, 32 may be at least partially used for positioning the seal 6, thereby simplifying the design of the arrangement 1. In particular, the valve's 2 inner contact surface 22 may be in direct contact with the seal 6. The valve 2 may comprise some components required for the functioning of the actuator 3. These components may be provided in the valve 2 portion, which is inserted into the actuator 3.

The actuator 3 comprises a motor for moving a valve element 25 via a magnetic coupling for closing and opening the valve 2. The magnetic coupling comprises an internal magnetic coupling rotor 26 and an external magnetic coupling rotor 27. The internal magnetic coupling rotor 26 and the external magnetic coupling rotor 27 are coupled to each other via magnetic forces. The internal magnetic coupling rotor 26 and the external magnetic coupling rotor 27 may comprise one or more magnets each. The internal magnetic coupling rotor 26 may be provided together with the valve 2. The magnetic coupling couples an actuator pinion 35 with a valve rotor spindle 28 via a hermetic sealing wall 29. The hermetic sealing wall 29 may be provided with the valve 2 and may contain the internal magnetic coupling rotor 26 of the magnetic coupling. The hermetic sealing wall 29 is fully or partially inserted into the actuator 3.

FIGS. 2a to 2c show different views of an embodiment of the clamp 4. The clamp 4 comprises two symmetrical, semi-circular halves, which are preferably permanently connected to each other by e.g. unscrewable screws 5. The two halves may be of a generally symmetrical shape, however, one of the halves may comprise tapped threaded holes, while the other halve may comprise simple though holes for the screws 5.

The clamp 4 comprises a valve contact surface 42 and an actuator contact surface 43, wherein the actuator contact surface 43 is arranged asymmetrically to the valve contact surface 42 with respect to a horizontal plane. The asymmetrical contact surfaces of the clamp 4 facilitate the connection of valves 2 and actuators 3, which have different diameters at their connection geometries 21, 31. In particular, the clamp 4 facilitates the connection of valves 2 and actuators 3, which are at least partially inserted into each other.

The two halves of the clamp 4 may define the actuator opening 44 and the valve opening 45, such that the two openings 44, 45 are situated radially within the halves. The unscrewable screws 5 may be any type of screws 5, which are screwable with respect to a tapped hole within the clamp 4 only to a degree, in which the screws 5 do not leave the tapped hole entirely. This means that the screws 5 cannot be unscrewed once they are screwed to the clamp 4, without destroying the screws and/or using additional special tools. The screws 5 may comprise some mechanism or some blocking portion, such as a circlip 51, which prevent the screws 5 from leaving the tapped hole entirely. The mechanism may be attached to the screws 5 once they have been inserted into the tapped hole within the clamp 4. Alternatively or additionally, the end of the screws may be deformed in manner whereby the screws cannot be unscrewed anymore, once they have been inserted into the tapped hole. The screws 5 may be positioned at the same axial position as or close to the actuator contact surface 43. The screws 5 may be positioned at the same axial position as the widest diameter portion of the clamp 4. The screws 5 may be positioned above and/or at a distance to the valve contact surface 42 with respect to an axial direction.

The actuator contact surface 43 is positioned further outside in a radial direction of the clamp 4 than the valve contact surface 42. The different radial positions of the contact surfaces 42, 43 further facilitate the connection of valves 2 and actuators 3, which may have different diameters at their connection geometries 21, 31.

The valve contact surface 42 is spaced apart from the actuator contact surface 43 in a radial direction of the arrangement. Spacing apart the contact surfaces 42, 43 from each other facilitates the connection of valves 2 and actuators 3 of differing diameters. The clamp 4 is shaped to fit closely to the valve 2 and actuator 3, thus keeping the weight and dimensions of the clamp 4 to a minimum.

The valve contact surface 42 is angled at a different slope than the actuator contact surface 43. The slopes of the contact surfaces 42, 43 of the clamp 4 may be adapted to the thicknesses of the corresponding contact surfaces of the actuator 3 and the valve 2, i.e. the outer contact surfaces 24, 34.

The thickness of the contact surfaces 24, 34, 42, 43 may correspond to their axial extension. For example, a thicker outer contact surface 24, 34 of the valve 2 or actuator 3 may be contacted by a steeper valve or actuator contact surface 42, 43 of the clamp 4. A steeper angle may correspond to an angle, which is closer to a 90° angle with respect to the axial direction of the clamp 4. In this sense, the angle of the actuator contact surface 43 is steeper than the angle of the valve contact surface 42 in FIG. 2a.

One embodiment of the invention comprises an actuator 3 and a clamp 4 for the presently described valve arrangement 1. In this embodiment, the clamp 4 is permanently connected to the actuator 3. The permanent connection may be provided by means of the unscrewable screws 5. The screws 5 may connect two halves of the clamp 4 such that the two halves cannot be disconnected without e.g. destroying the screws 5. The screws 5 may be provided such that they cannot be unscrewed with normal screwing tools used for unscrewing screws such as screw drivers, wrenches, or spanners. The unscrewable screws 5 may each comprise some blocking mechanism which prevents their unscrewing. The blocking mechanism may be a structural blocking component of the screws 5, which prevents the screws 5 from being fully moved out of the clamp 4. The blocking component of the screws 5 may be provided at an end of the screws 5 opposite a screw head. An unscrewing motion may hence be blocked such that the screws 5 cannot be unscrewed from their e.g. nuts or threaded holes provided at the clamp 4.

The two halves of the clamp 4 may be connected sufficiently close to each other, such that the clamp 4 permanently holds the actuator connection geometry 31.

Another embodiment of the invention is directed at a method for assembling the presently described valve arrangement. The method comprises a first step, in which the actuator 3 and the clamp 4 are mounted onto the valve 2, while the actuator 3 and the clamp 4 are connected to each other, and a second step, in which the clamp 4 is fastened to both, the actuator 3 and the valve 2. The fastening of the clamp 4 to the actuator 3 and the valve 2 may comprise the tightening of screws 5 to the clamp 4 for establishing a rigid connection between the clamp 4, the actuator 3 and the valve 2.

In the first step, the clamp 4 and the actuator 3 may be preferably permanently connected to each other, prior to the mounting of the actuator 3 and the clamp 4 onto the valve 2. The clamp 4 may be permanently coupled to the actuator 3. However, the clamp 4 may be movable to some degree with respect to the actuator 3, as long as the screws 5 are not tightly screwed to the clamp 4.

A further embodiment of the invention is directed at an actuator 3 for actuating a valve 2, and a clamp 4 for fixing the actuator 3 to the valve 2 The actuator 3 comprises an actuator connection geometry 31 with an inner contact surface 32 for contacting the actuator 3 to the valve 2, wherein the actuator connection geometry 31 comprises a radially outward pointing protrusion 33 with an outer contact surface 34 for contacting the clamp 4, wherein the outer contact surface 34 is shaped at least partially as a frustum, and wherein the clamp 4 is permanently connected to the actuator 3. The permanent connection between the clamp 4 and the actuator 3 may be provided in the previously described manner.

FIG. 3 shows a perspective view of an embodiment of the valve arrangement 1 in an assembled state. The clamp 4 is screwed tightly by means of the screws 5. The valve 2 and the actuator 3 are firmly held together by the clamp 4. The valve 2 comprises two fluid ports. All of the valve's fluid ports and internal fluid conduits are provided at the side of the valve 2 opposite the actuator 3 with respect to the clamp 4.

1. Valve arrangement (1) comprising a valve (2) with a valve connection geometry (21), an actuator (3) with an actuator connection geometry (31), and a clamp (4) fixing the valve (2) to the actuator (3), wherein each connection geometry (21, 31) comprises an inner contact surface (22, 32) for contacting the valve (2) to the actuator (3), and wherein each connection geometry (21, 31) comprises a radially outward pointing protrusion (23, 33), each with an outer contact surface (24, 34) for contacting the clamp (4), wherein each outer contact surface (24, 34) is shaped at least partially as a frustum.

2. Valve arrangement (1) comprising a valve (2) with two fluid ports and a valve connection geometry (21), an actuator (3) with an actuator connection geometry (31), and a clamp (4) fixing the valve (2) to the actuator (3), wherein each connection geometry (21, 31) comprises an inner contact surface (22, 32) for contacting the valve (2) to the actuator (3), and wherein each connection geometry (21, 31) comprises a radially outward pointing protrusion (23, 33), each with an outer contact surface (24, 34) for contacting the clamp (4), wherein each outer contact surface (24, 34) is shaped at least partially as a frustum.

3. Valve arrangement (1) according to claim 1 or 2, characterized in that the clamp (4) comprises a valve contact surface (42) and an actuator contact surface (43), wherein the actuator contact surface (43) is arranged asymmetrically to the valve contact surface (42) with respect to a horizontal plane and/or that all fluid passages of the valve (2) are provided below the valve connection geometry (21).

4. Valve arrangement (1) according to claim 3, characterized in that the actuator contact surface (43) is positioned further outside or inside in a radial direction of the arrangement than the valve contact surface (42).

5. Valve arrangement (1) according to claim 3 or 4, characterized in that the valve contact surface (42) is spaced apart from the actuator contact surface (43) in a radial direction of the arrangement.

6. Valve arrangement (1) according to any of claims 3 to 5, characterized in that the valve contact surface (42) is angled at a different slope than the actuator contact surface (43).

7. Valve arrangement (1) according to any of the previous claims, characterized in that the clamp (4) comprises an actuator opening (44) for inserting the actuator (3) and a valve opening (45) for inserting the valve (2), wherein the actuator opening (44) has a greater or smaller diameter than the valve opening (45) and/or that the clamp (4) is permanently connected to the actuator (3) and/or that the clamp (4) comprises two symmetrical halves, which are preferably permanently connected to each other by unscrewable screws (5).

8. Valve arrangement (1) according to any of the previous claims, characterized in that a seal (6) is provided between the valve (2) and the actuator (3), wherein the seal (6) is arranged radially inside the inner contact surfaces (22, 32) and/or that the valve (2) is inserted at least partially into the actuator (3) and/or that the valve connection geometry (21) and/or the actuator connection geometry (31) and/or a roller bearing (7) are provided at the same axial position of the arrangement.

9. Actuator (3) and clamp (4) for a valve arrangement according to any of claims 1 to 9, characterized in that the clamp (4) is permanently connected to the actuator (3).

10. Method for assembling a valve arrangement according to any of claims 1 to 9, characterized in that,
in a first step, the actuator (3) and the clamp (4) are mounted onto the valve (2), while the actuator (3) and the clamp (4) are connected to each other, and
in a second step, the clamp (4) is fastened to both, the actuator (3) and the valve (2).

11. Method according to claim 11 for assembling a valve arrangement according to at least claim 8, characterized in that
in the first step, the valve (2) is inserted into the clamp (4) through the valve opening (45) of the clamp (4), and/or
in the second step, the clamp (4) is fastened by turning the screws (5).

12. Actuator (3) for actuating a valve (2), and a clamp (4) for fixing the actuator (3) to the valve (3), wherein the actuator (3) comprises an actuator connection geometry (31) with an inner contact surface (32) for contacting the actuator (3) to the valve (2), wherein the actuator connection geometry (31) comprises a radially outward pointing protrusion (33) with an outer contact surface (34) for contacting the clamp (4), wherein the outer contact surface (34) is shaped at least partially as a frustum, characterized in that the clamp (4) is permanently connected to the actuator (3).

13. Clamp (4) for a valve arrangement according to any of claims 1 to 8, characterized in that the clamp (4) comprises a valve contact surface (42) and an actuator contact surface (43) of different shapes and dimensions.

14. Clamp (4) according to claim 14, characterized in that the clamp (4) comprises two preferably symmetrical halves, which are preferably permanently connected to each other by unscrewable screws (5).
